(19) United States
(12) Patent Application Publication
(10) Pub. No.: US 2021/0150922 A1
(43) Pub. Date: May 20, 2021

(54) USING VEHICLE LIGHTS FOR COLLISION AWARENESS

(71) Applicant: Honeywell International Inc., Morris Plains, NJ (US)

(72) Inventors: Sivakumar Kanagarajan, Madurai (IN); Gobinathan Baladhandapani, Madurai (IN); Dinkar Mylaraswamy, Phoenix, AZ (US)

(21) Appl. No.: 16/775,148

(22) Filed: Jan. 28, 2020

(30) Foreign Application Priority Data
Nov. 19, 2019 (IN) 201911047197

(51) Int. Cl. G08G 5/04; B64D 47/08

(52) U.S. Cl. CPC G08G 5/045; G01S 13/933; B64D 47/08

(57) ABSTRACT

In some examples, a system includes a memory configured to store a threshold level for collision prediction. The system also includes processing circuitry configured to determine that a collision likelihood at a potential collision location between the vehicle and an object is greater than or equal to the threshold level. The processing circuitry is also configured to cause one or more lights mounted on the vehicle to direct light towards the potential collision location or towards the object in response to determining that the collision likelihood for the vehicle is greater than or equal to the threshold level.

This application claims the benefit of Indian Provisional Patent Application No. 201911047197, filed Nov. 19, 2019, the entire content of which is incorporated herein by reference.

### TECHNICAL FIELD

This disclosure relates to collision awareness for vehicles.

### BACKGROUND

There are some areas where vehicle collisions are more likely to occur, such as roadway intersections and certain areas of airports. The attention of a vehicle operator may be split between many tasks when operating in these areas. For example, a vehicle operator may be watching a traffic light, looking for pedestrians, watching oncoming traffic and cross traffic, and maintaining the speed of the vehicle.

As another example, at an airport and during a ground maneuver of an aircraft, a pilot may be looking for traffic such as other aircraft, employees on foot, and ground vehicles such as automobiles, tow tugs, and baggage carts. The pilot may also be paying attention to the protrusions on an aircraft such as the wingtips and tail as the pilot navigates the aircraft on the ground. This traffic and the structures of the airport may be potential obstacles with which the vehicle may collide. Confusion about airport design and markings can result in a flight crew error or a controller error, which may lead to an inadvertent collision (e.g., a wingtip collision) between the aircraft and another vehicle or an airport structure.

Wingtip collisions during ground operations are a key concern to the aviation industry, particularly as the volume of aircraft and the surface occupancy in the space around airport terminals increases, and as the number of different kinds of airframes increases. With increasing air travel, terminal utilization at airports is trending towards full capacity. Airports can have major operational disruptions when an aircraft collides with another aircraft or an airport structure while conducting ground operations. Aircraft damage, even for slow-moving collisions, can lead to expensive and lengthy repairs, which can result in operational issues for air carriers. The risk of wingtip collisions can increase as airlines upgrade their fleets because pilots may be less accustomed to the particular wingspan and wing shapes such as winglets and sharklets of the newer aircraft.

### SUMMARY

In general, this disclosure relates to systems, devices, and techniques for providing collision awareness using one or more lights mounted on a vehicle. A system implementing the techniques of this disclosure can determine whether the likelihood of a collision at a potential collision location involving the vehicle and an object is greater than or equal to a threshold level. In response to determining that the collision likelihood is greater than or equal to the threshold level, the system may cause one or more lights mounted on the vehicle to direct light towards the potential collision location and/or towards the object. The light may, therefore, notify an occupant of the object (if occupied) of the potential collision, as well as provide the operator of the vehicle (e.g., a pilot of an aircraft) with a notification of the potential collision and a potentially more clear view of the potential collision location.

The details of one or more examples of the disclosure are set forth in the accompanying drawings and the description below. Other features, objects, and advantages will be apparent from the description, drawings, and claims.

### BRIEF DESCRIPTION OF THE DRAWINGS

FIG. 1 is a conceptual block diagram of an example collision awareness system that is configured to cause a vehicle lighting system to direct light towards a potential collision location or towards an object.

FIG. 2 is a diagram of lights mounted on an example vehicle.

FIG. 3 is a conceptual block diagram of possible data sources for a collision awareness system.

FIG. 4 is a diagram showing examples of potential collision locations at an airport.

FIGS. 5A-5D are diagrams of an example scenario showing two vehicles maneuvering near an airport terminal.

FIG. 6 is a diagram showing an example graphical user interface including example indications of potential collision locations.

FIGS. 7 and 8 are flowcharts illustrating example processes for activating lights based on a collision likelihood.

FIG. 9 is a flowchart illustrating an example process for activating an automatic brake system.

FIG. 10 is a flowchart illustrating an example process for generating an alert based on a collision prediction.

### DETAILED DESCRIPTION

Various example devices, systems, and techniques for providing collision awareness by causing one or more lights mounted on a vehicle to direct light towards a potential collision location or towards an object are described herein. In some examples, a system (also referred to herein as a collision awareness system) is configured to determine the likelihood of a collision between the vehicle and the object at a potential collision location, and determine whether the collision likelihood is greater than or equal to a threshold level and activating the one or more lights in response to determining that the collision likelihood is greater than or equal the threshold level. In some examples, the system is configured to determine the likelihood of a collision by at least determining the locations of the vehicle and the object (e.g., another vehicle or a non-vehicle object, such as an airport structure) and determining whether they are within a threshold distance of each other. The threshold distance may be predetermined and, in some examples, may differ depending on the type of vehicle, the speed of the vehicle on the ground, the direction of movement of the vehicle, and the like.

By directing light towards the potential collision location or towards the object, the collision awareness system can alert the vehicle operator of the potential collision in the area of a potential collision. In some examples, the techniques of this disclosure can be used alongside other alerting techniques, such as visual alerts, audible alerts, and tactile alerts presented by vehicle systems to operators and other crewmembers. In some examples, directing the light towards the potential collision location can also provide the vehicle operator with a better view of the potential collision location, which may help the vehicle operator take a more responsive action to help prevent the potential collision.

The activation of a vehicle lighting system can also provide notice to persons nearby the potential collision location that a potential collision may occur. For example, if the object is another vehicle or is otherwise occupied by an occupant, the activation of the vehicle lighting system can notify the occupant of the object of the potential collision and/or the potential collision location.

Although the techniques of this disclosure can be used for any type of vehicle, the techniques of this disclosure may be especially useful at airports for monitoring aircraft that are performing ground operations. Ground operations for aircraft at an airport can include, for example, taking off, landing, taxiing (e.g., on taxiways, aprons, at the gate area, across runways, at the end of runways, etc.), parking at the gate area, waiting for a clearance to move onto or across a runway, and the like. During ground operations, the wingtips and tails of the aircraft are relatively vulnerable to collisions with other vehicles and with stationary objects to the extent to which the wingtips and tails protrude from the aircraft fuselage. It may be relatively difficult for the flight crew to assess the positions of the wingtips and tail of an aircraft, especially for larger aircraft. For at least this reason, wingtip-to-wingtip collisions and wingtip-to-tail collisions can be difficult for a pilot to predict. Collisions at airports can cause millions of dollars in damage and result in flight delays for travelers.

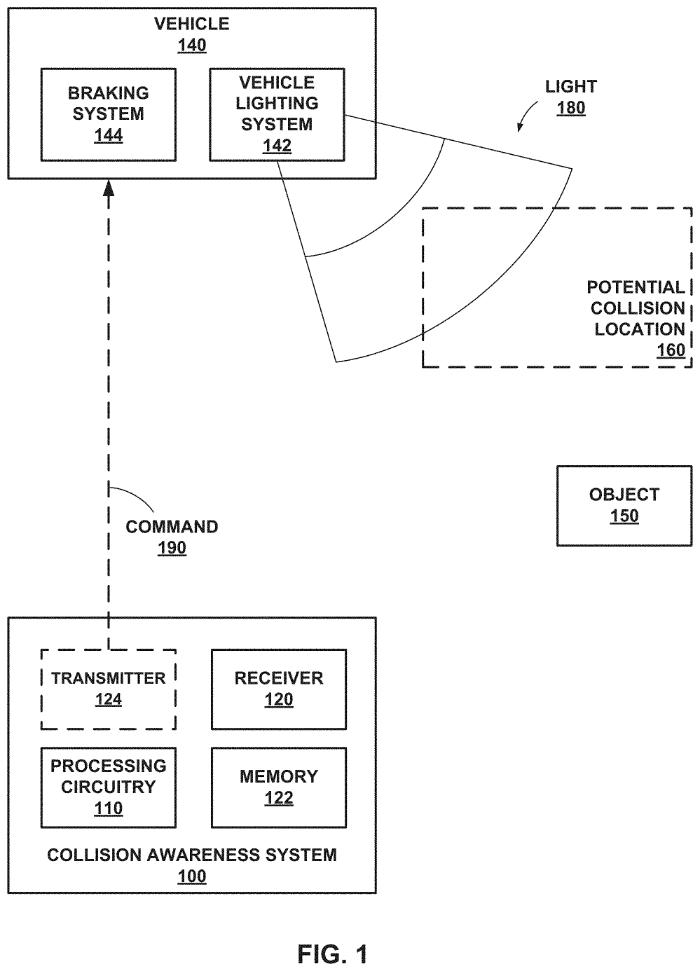

FIG. 1 is a conceptual block diagram of an example collision awareness system 100 configured to cause a vehicle lighting system 142 to direct light towards a potential collision location 160 or towards an object 150. Collision awareness system 100 includes processing circuitry 110, receiver 120, memory 122, and optional transmitter 124. Collision awareness system 100 is configured to predict a potential collision between vehicle 140 and object 150. In response to determining that the likelihood of a collision is greater than or equal to a threshold level, collision awareness system 100 can transmit command 190 to vehicle 140 to cause vehicle lighting system 142 to direct beam of light 180 towards potential collision location 160 or towards object 150.

Processing circuitry 110 may be configured to predict potential collisions based on data received by receiver 120 and/or data stored by memory 122. For example, receiver 120 may include a radar sensor that is configured to receive reflected signals indicating the locations and velocities of vehicle 140 and object 150. Additionally or alternatively, receiver 120 may be configured to receive a surveillance message from vehicle 140 or object 150 indicating the location and velocity of vehicle 140 or object 150. Other potential data sources for processing circuitry 110 to predict potential collisions include traffic controller clearances, images of vehicle 140 or object 150, and Global Navigation Satellite System (GNSS) data. Additional example details of predicting potential collisions can be found in commonly assigned U.S. patent application Ser. No. 16/459,411, entitled “Collision Awareness System for Ground Operations,” filed on Jul. 1, 2019, which is incorporated by reference in its entirety.

Processing circuitry 110 may include any suitable arrangement of hardware, software, firmware, or any combination thereof, to perform the techniques attributed to processing circuitry 110 herein. Examples of processing circuitry 110 include any one or more microprocessors, digital signal processors (DSPs), application specific integrated circuits (ASICs), field programmable gate arrays (FPGAs), or any other equivalent integrated or discrete logic circuitry, as well as any combinations of such components. When processing circuitry 110 includes software or firmware, processing circuitry 110 further includes any necessary hardware for storing and executing the software or firmware, such as one or more processors or processing units.

In general, a processing unit may include one or more microprocessors, DSPs, ASICs, FPGAs, or any other equivalent integrated or discrete logic circuitry, as well as any combinations of such components. Collision awareness system 100 may include memory 122 configured to store data such as, but not limited to, any one or more of the locations, velocities, and other characteristics of vehicle 140 and object 150, threshold level(s) for collision likelihoods, or a map of an area including potential collision location 160. Memory 122 may include any volatile or non-volatile media, such as a random access memory (RAM), read only memory (ROM), non-volatile RAM (NVRAM), electrically erasable programmable ROM (EEPROM), flash memory, and the like. In some examples, memory 122 may be external to processing circuitry 110 (e.g., may be external to a package in which processing circuitry 110 is housed).

In some examples, processing circuitry 110 is configured to generate command 190 in response to predicting a potential collision between vehicle 140 and object 150. Processing circuitry 110 can transmit command 190 to vehicle 140 and, in some examples, to object 150. For example, processing circuitry 110 can transmit command 190 to vehicle 140 to cause vehicle lighting system 142 to activate one or more lights mounted on vehicle 140. Additionally or alternatively, braking system 144 can apply the brakes to slow or stop vehicle 140 in response to vehicle 140 receiving command 190. Additional example details of auto-braking can be found in commonly assigned U.S. patent application Ser. No. 16/009,852, entitled “Methods and Systems for Vehicle Contact Prediction and Auto Brake Activation,” filed on Jun. 15, 2018, which is incorporated by reference in its entirety.

Receiver 120 may be configured to receive data indicating the locations of vehicle 140 and object 150. Receiver 120 may include a radar receiver, a camera, a sensor, a surveillance receiver, a GNSS receiver, a wireless or wired receiver, a radio-frequency receiver, an audio receiver, and/or any other receiver configured to receive data, signals, and/or messages indicating the locations of vehicle 140 and object 150. In some examples, receiver 120 can also receive other travel data (e.g., destination, starting point, heading, velocity, current and future maneuvers, etc.) for vehicle 140 and/or object 150. Collision awareness system 100 can include a single receiver or separate receivers for receiving data from vehicle 140, object 150, and other data sources. In some examples, collision awareness system 100 can be a stand-alone system or can be built-in or connected to one or more of the data sources, such as a system onboard vehicle 140, a system onboard object 150, or a part of a traffic controller system.

Receiver 120 may include a surveillance receiver configured to receive surveillance messages indicating the position and velocity of vehicle 140 and/or object 150. For example, receiver 120 may include an automatic-dependent surveillance-broadcast (ADS-B) receiver, a traffic collision avoidance system (TCAS) receiver, a datalink receiver, an automatic identification system (AIS) receiver, and/or any other surveillance receiver. Vehicle 140 and/or object 150 may send surveillance messages to receiver 120 that include data indicating the location and velocity of vehicle 140 and/or object 150.

Vehicle 140 may be any mobile object. In some examples, vehicle 140 may be an aircraft such as an airplane. For example, vehicle 140 may be aircraft that conducts ground operations at an airport and receive clearances (e.g., instructions or commands) from a traffic controller. In yet other examples, vehicle 140 may include a land vehicle such as an automobile or a water vehicle such as a ship or a submarine. Vehicle 140 may be a manned vehicle or an unmanned vehicle, such as a drone, a remote-control vehicle, or any suitable vehicle without any pilot or crew on board. Object 150 may be any vehicle, mobile object, and/or stationary object. For example, object 150 may be a building, a pole, a sign, a tree, a terrain obstacle (e.g., a hill, slope, or ravine), a person or other animal, debris, and/or any other object. In some examples, object 150 is an airport structure, such as, but not limited to, a building, a pole, a sign, a light, or the like. Additionally or alternatively, object may be a mobile airport object, such as a baggage cart, a tow tug, a ground crew member, a delivery vehicle, or the like.

Processing circuitry 110 is configured to determine the likelihood of a collision between vehicle 140 and object 150 using in any suitable technique. In some examples, processing circuitry 110 receives an indication of a likelihood of collision from another device, such as, but not limited to, object 150, ground control at an airport, from vehicle 140 (in examples in which system 100 is not onboard vehicle 140), or the like. In other examples, processing circuitry 110 detects object 150 and determines the likelihood of a collision between vehicle 140 and object 150 based on the locations of vehicle 140 and object 150. For example, processing circuitry 110 may be configured to determine that a potential collision could occur at potential collision location 160 based on the travel paths and projected future positions of vehicle 140 and object 150. In response to processing circuitry 110 determining that a collision likelihood at potential collision location 160 is greater than or equal to a threshold level, collision awareness system 100 can generate and transmit an alert signal to vehicle 140 and/or object 150. The alert signal may notify the operator of vehicle 140 and/or object 150 of the potential collision between vehicle 140 and object 150 using a visual, audible, and/or tactile alert. However, the operator of vehicle 140 and/or object 150 may not immediately react to the alert generated by collision awareness system 100. For example, the operator of vehicle 140 and/or object 150 may be paying attention to the travel path of vehicle 140 or object 150 and not observe the alert.

In accordance with example techniques of this disclosure, in response to determining that a collision likelihood at potential collision location 160 is greater than or equal to a threshold level, collision awareness system 100 sends command 190 to vehicle 140 to cause vehicle lighting system 142 to direct light, e.g., beam of light 180 in examples described herein, towards potential collision location 160 and/or towards object 150. Potential collision location 160 may be in the travel paths of vehicle 140 and/or object 150, such that beam of light 180 may be observable by the operators of vehicle 140 and/or object 150 (to the extent object 150 has an operator). In some examples, beam of light 180 can serve as an additional means of notifying vehicle 140, object 150, and/or other persons of the likelihood of a potential collision at potential collision location 160. In some examples, collision awareness system 100 can also send a command to object 150 to cause one or more lights mounted on object 150 to direct a beam of light towards vehicle 140 or towards potential collision location 160.

Additionally or alternatively, collision awareness system 100 may be configured to send a command to a light that is not mounted on vehicle 140 or object 150 to cause the light to direct a beam of light towards vehicle 140, object 150, or potential collision location 160. In this way, collision awareness system 100 can cause a light that is mounted on a stationary object proximate vehicle 140, object 150, or potential collision location 160 to alert an operator of vehicle 140 or object 150 of a potential collision. Examples of such lights, e.g., at an airport, include but are not limited to, a runway light, a taxiway light, a taxiway sign, a runway guard light, a stop bar light, an approach light, a beacon, and/or any other airport light configured to direct a beam of light towards vehicle 140, object 150, or potential collision location 160.

By activating one or more lights on vehicle 140, collision awareness system 100 can bring more reach and visibility to a potential collision, as compared to a vehicle system that alerts only the operator of the vehicle. Collision awareness system 100 can use external lights on vehicle 140 to bring immediate attention to everyone in the area that the likelihood of a collision is greater than a threshold level. In some examples, beam of light 180 directed towards potential collision location 160 can also provide an operator of vehicle 140, object 150 (if object 150 has an operator), and/or others near potential collision location 160 with a better view of potential collision location 160 by better illuminating potential collision location 160.

Vehicle lighting system 142 includes one or more lights mounted on vehicle 140 (e.g., on an exterior of vehicle 140 and visible on the exterior of vehicle 140). In examples in which vehicle 140 is an automobile, vehicle lighting system 142 can include headlights, taillights, brake lights, turn signal lights, and/or any other lights mounted on vehicle 140. In examples in which vehicle 140 is an aircraft, vehicle lighting system 142 can include taxi lights, runway turnoff lights, landing lights, wing inspection lights, position or navigation lights, anti-collision lights, pulsing lights, logo lights, and/or any other lights mounted on vehicle 140. Vehicle lighting system 142 may include existing lights on vehicle 140 and/or lights added to vehicle 140 solely for the purpose of implementing the techniques of this disclosure and/or providing general collision awareness. In some examples, some or all of the lights on vehicle 140 may be stationary lights that are configured to direct beam of light 180 in a predefined direction based on the orientation of vehicle 140. In some examples, collision awareness system 100 sends command 190 to vehicle 140 to cause the stationary light to direct beam of light 180 towards object 150 or potential collision location 160. In some examples, potential collision location 160 can move over time, and vehicle lighting system 142 may be configured to move or adjust beam of light 180 to continue pointing towards potential collision location 160. Movement of potential collision location 160 may indicate that the distance between vehicle 140 and object 150 is decreasing.

Additionally or alternatively, vehicle lighting system 142 may include one or more movable lights that are configured to be turned (e.g., rotated) relative to vehicle 140. Collision awareness system 100 may be configured to cause the movable light to point towards object 150 or towards potential collision location 160 so that the movable light can direct beam of light 180 towards object 150 or towards potential collision location 160.

In some examples, collision awareness system 100 and/or vehicle lighting system 142 is configured to activate only one light or only a certain set of lights of a plurality of lights in response to determining that the collision likelihood for vehicle 140 is greater than or equal to a threshold level. In other examples, collision awareness system 100 and/or vehicle lighting system 142 can select the one or more lights to activate from a plurality of available lights based on the target direction or target location for beam of light 180. For example, to direct beam of light 180 ahead of vehicle 140, collision awareness system 100 and/or vehicle lighting system 142 can activate a light at the front of vehicle 140, such as a nose light, a headlight, or a light on the front landing gear of vehicle 140 (e.g., a landing light or a taxi light). As another example, to direct beam of light 180 towards an area ahead of and to the side of vehicle 140, collision awareness system 100 and/or vehicle lighting system 142 can activate a wingtip light that faces forward, such as a forward-facing wingtip navigation light. Additional example details of alerting members of a ground crew using a device mounted on landing gear can be found in commonly assigned U.S. Pat. No. 9,207,319, entitled “Collision-Avoidance System for Ground Crew Using Sensors,” issued on Dec. 8, 2015, which is incorporated by reference in its entirety.

By causing one or more lights of vehicle lighting system 142 to generate beam of light 180, collision awareness system 100 can alert vehicle operators, crew members, and other observers near potential collision location 160 to the possibility of a collision between vehicle 140 and object 150. Collision awareness system 100 may be configured to operate without any input by the operators or crew members of vehicle 140 and object 150, thus providing an additional layer of collision awareness to persons near potential collision location 160.

In addition to causing vehicle lighting system 142 to direct beam of light 180 towards object 150 or potential collision location 160, in some examples, collision awareness system 100 is configured to activate braking system 144 of vehicle 140 to cause vehicle 140 to slow down or stop. For example, collision awareness system 100 can send command 190 to vehicle 140 to activate braking system 144 to cause vehicle 140 to slow down and/or stop short of potential collision location 160. Instead of causing braking system 144 to automatically activate in response to determining that the collision likelihood for vehicle 144 at the potential collision location is greater than or equal to the threshold level, collision awareness system 100 may be configured to first cause vehicle 140 to present a message to the operator of vehicle 140 instructing or suggesting that the operator apply the brakes of vehicle 140. If the operator does not apply the brakes of vehicle 140, and if the collision likelihood increases, then braking system 144 can apply the brakes without user input. In some examples, collision awareness system 100 is also configured to send command 190 to vehicle 140 and/or object 150 to cause vehicle 140 and/or object 150 to generate an alert for the operator or crewmembers of vehicle 140 and/or object 150 to notify the operator or other crewmembers of the increased collision likelihood for vehicle 144. The alert may be a visual alert, an audible alert, a tactile alert, and/or any other type of alert.

To determine whether to send command 190 to activate vehicle lighting system 142, processing circuitry 110 may be configured to compare the likelihood of a collision at potential collision location 160 to a threshold level. Although described herein as a determination of whether the collision likelihood is greater than or equal to the threshold level, in some examples, the determination may also be whether the collision likelihood is greater than the threshold level. The threshold level may be an amount of time (e.g., a numerical time value), a distance (e.g., a numerical distance value), or any other parameter indicative of a likelihood of collision of vehicle 144 and object 150. For example, processing circuitry 110 can determine the amount of time until vehicle 140 and/or object 150 arrives at potential collision location 160 if vehicle and object 150 maintain the current or expected path of relative movement. In response to determining that the amount of time before vehicle 140 and/or object 150 arrives at potential collision location 160 is less than or equal to a threshold amount of time, processing circuitry 110 can send command 190 to vehicle 140. Thus, in some examples, processing circuitry 110 can determine that the collision likelihood at potential collision location 160 is greater than or equal to a threshold level by at least determining that the time until arrival at potential collision location 160 for vehicle 140 and/or object 150 is less than or equal to a threshold amount of time. The threshold time may be between two and twenty seconds, such as between three and fifteen seconds, in some examples.

Additionally or alternatively, the threshold level is a distance value and processing circuitry 110 can determine the distance between vehicle 140 and potential collision location 160 and/or the distance between object 150 and potential collision location 160. In response to determining that one or both of these distances is less than or equal to a threshold distance, processing circuitry 110 can send command 190 to vehicle 140. Thus, in some examples, processing circuitry 110 can determine that the collision likelihood at potential collision location 160 is greater than or equal to a threshold level by at least determining that the distance between potential collision location 160 and vehicle 140 and/or object 150 is less than a threshold distance. The threshold distance may be between fifty and five hundred meters, such as between one hundred and four hundred meters, in some examples.

To determine the likelihood of a collision, system 100 can use data from sources such as range sensors (e.g., radar or lidar), images captured by cameras, surveillance messages (e.g., ADS-B), clearances from a traffic controller, and/or any other data sources. Processing circuitry 110 may be configured to determine a collision threat exists in response to determining that another vehicle (e.g., object 150) has crossed a safety margin. For example, if vehicle 140 is moving on a runway and the other vehicle is approaching the runway from a taxiway, then processing circuitry 110 can determine that a collision threat exists in response to determining that the other vehicle has crossed a threshold line that represents a runway incursion. Processing circuitry 110 may be configured to send command 190 to vehicle 140 to cause vehicle lighting system 142 to direct light 180 towards the other vehicle once processing circuitry 110 determines that the other vehicle has crossed the threshold line.

To determine whether a collision likelihood is greater than or equal to a threshold level, processing circuitry 110 can also determine future position(s) of vehicle 140 and/or object 150. In some examples, to determine that the collision likelihood is greater than or equal to a threshold level, processing circuitry 110 can (virtually) define safety envelopes or buffer areas (e.g., a volumetric region) around vehicle 140 and object 150 and determine whether the safety envelopes or buffer areas overlap at the future position(s) of vehicle 140 and/or object 150. Thus, in some examples, processing circuitry 110 can determine the likelihood of a collision at potential collision location 160 based on any overlap or a threshold amount of overlap (as defined by a distance value or a volumetric value) of the safety envelopes or buffer areas of vehicle 140 and/or object 150. Additional example details of using safety envelopes can be found in commonly assigned U.S. Patent Application Publication No. 2015/0329217, entitled “Aircraft Strike Zone Display,” filed on May 19, 2014, and commonly assigned U.S. Pat. No. 9,229,101, entitled “Systems and Methods for Performing Wingtip Protection,” issued on Jan. 5, 2016, each of which is incorporated by reference in its entirety.

In some examples, processing circuitry 110 may be configured to select or adjust the threshold level based on the characteristics of vehicle 140, the characteristics of object 150, the characteristics of the environment in which vehicle 140 is operating, and/or any other parameters. For example, processing circuitry 110 can select a more sensitive threshold level for larger vehicles (e.g., heavier vehicles, longer wingspans, longer stopping distances, etc.), faster speeds, heavier traffic, and/or worse environmental conditions (e.g., nighttime, fog, precipitation, icy surfaces, etc.) than for smaller vehicles, slower speeds, lighter traffic, and/or relatively better environmental conditions.

In some examples, processing circuitry 110 can use multiple threshold levels, such as a critical threshold level indicating a higher collision likelihood (e.g., a more urgent collision threat) and a non-critical threshold level indicating a lower collision likelihood, and respective lighting parameters for beam of light 180. For example, in response to determining that the collision likelihood is greater than or equal to the non-critical threshold level, processing circuitry 110 may be configured to cause vehicle lighting system 142 to activate one or more lights in a first pattern. In addition, in response to determining that the collision likelihood is greater than or equal to the critical threshold level, processing circuitry 110 may be configured to cause vehicle lighting system 142 to activate one or more lights in a second pattern different than the first pattern. The second pattern may include brighter lights, more luminous lights, a higher number of activated lights, and/or higher frequency of flashing lights, as compared to the first pattern.

In some examples, in addition to or instead of selecting a light parameter based on a selected threshold level, processing circuitry 110 may be configured to select a first or second pattern of illumination (or other lighting parameters such as brightness and/or color, in other examples) based on other factors, such as the location of potential collision location 160, the presence of pedestrians near potential collision location 160, and/or the number of vehicles near potential collision location 160. Processing circuitry 110 may be configured to select a lighting pattern that is based on the area of an airport in which potential collision location 160 is located, with different lighting patterns for runways, taxiways, aprons, gates, intersections, and other areas. For example, in some examples in which potential collision location 160 is located on a runway of an airport, processing circuitry 110 can use a first pattern indicating a more critical collision threat, as compared to examples in which potential collision location 160 is located in a taxiway, on an apron, or at a gate of an airport.

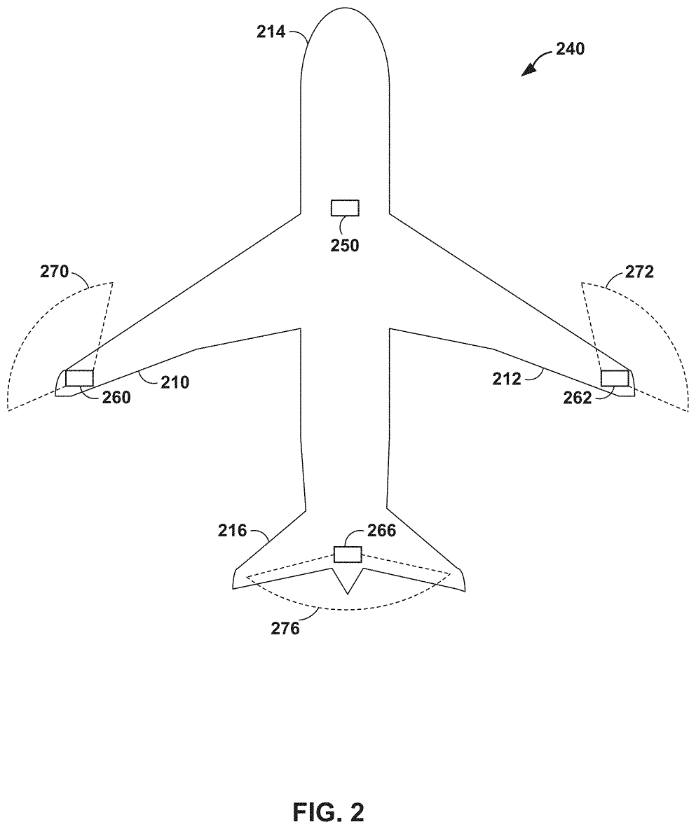

FIG. 2 is a diagram of lights 250, 260, 262, and 266 mounted on an example vehicle 240, which is an example of vehicle 140 of FIG. 1. Lights 250, 260, 262, and 266 may be part of a vehicle lighting system, such as vehicle lighting system 142 shown in FIG. 1. In some examples, each of lights 250, 260, 262, and 266 is configured to emit light in a predefined direction or field of illumination. Light 260, for example, may be configured to emit a beam of light into illumination area 270. Each of lights 250, 260, 262, and 266 may include a stationary light and/or a moving light.

Vehicle 240 is depicted in FIG. 2 as an airplane, but other vehicles may also include lights that can be used to direct light towards a potential collision location or towards an object with which vehicle 240 may collide. For example, an automobile or a helicopter may include lights mounted on the exterior of the automobile that can be used to perform the techniques of this disclosure.

In examples in which vehicle 240 is an airplane, light 250 may include one or more taxi lights mounted on the nose gear strut for illuminating the area in front of nose 214 of vehicle 240. Additionally or alternatively, light 250 can include one or more runway turnoff lights mounted on the nose gear strut for illuminating the area(s) to the side of nose 214 of vehicle 240. Light 250 can include landing lights mounted on the landing gear of vehicle 240. Light 250 can also include a red anti-collision rotating beacon. Vehicle 240 may also include taxi lights and/or runway turnoff lights at locations other than the location of light 250 as depicted in FIG. 2, such as a location mounted on wings 210 and 212 of vehicle 240.

In some examples, light 260 may include a red position light, and light 262 may include a green position light. The red and green position lights of lights 260 and 262 may be configured to illuminate respective areas 270 and 272. In addition to or instead of the red and green position lights, in some examples, lights 260 and 262 may also include white position lights and/or light 266 mounted on tail 216 may include a white position light configured to illuminate area 276. Position lights may also be referred to as navigation lights.

A system configured to implement the techniques of this disclosure may be part of vehicle 240 or may be located remotely from vehicle 240. For example, the system (e.g., a collision awareness system, such as system 100 of FIG. 1) could be part of a control system, a cockpit system, and/or an avionics bay of vehicle 240. The system can also be located outside of vehicle 240, such as onboard another vehicle or part of a controller system. Additionally or alternatively, the techniques of this disclosure can be implemented jointly by processing circuitry inside and outside of vehicle 240. In other words, processing circuitry mounted onboard vehicle 240 may be configured to perform some of the functionality described herein, and processing circuitry outside of vehicle 240 may be configured to perform the rest of the functionality described herein.

The system can activate lights 250, 260, 262, and/or 266 in response to determining that the likelihood of a collision is greater than a threshold level. In examples in which the system is onboard vehicle 240, the system may be configured to send a command to the vehicle lighting system to cause lights 250, 260, 262, and/or 266 to be activated. In examples in which the system is not onboard vehicle 240, the system can transmit a command to a receiver onboard vehicle 240 to cause the vehicle lighting system to activate lights 250, 260, 262, and/or 266.

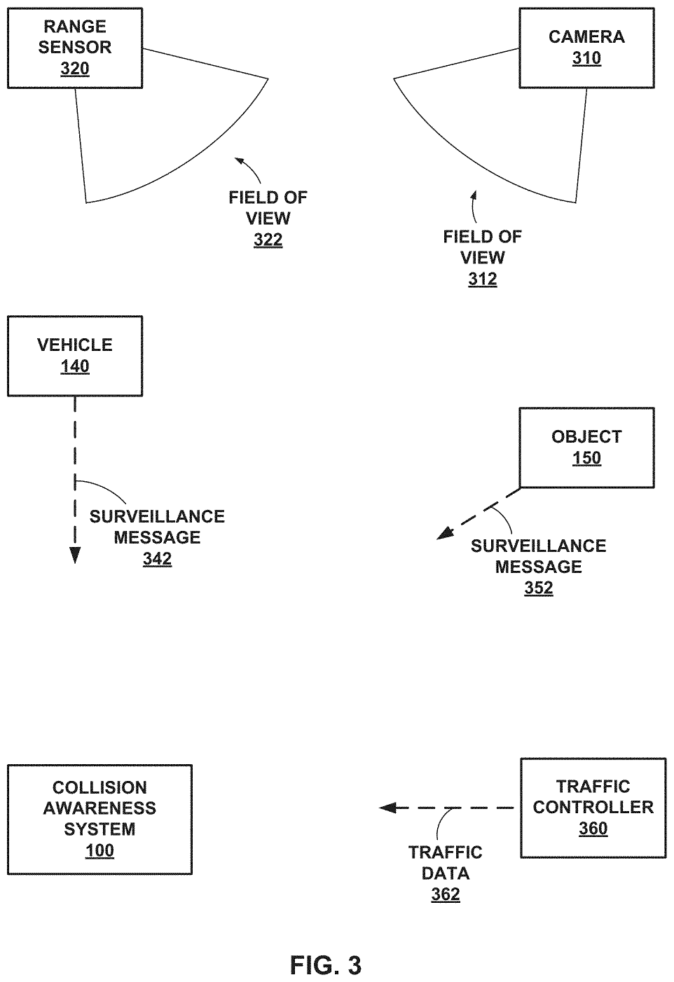

FIG. 3 is a conceptual block diagram of possible data sources 310, 320, 140, 150, and 360 for a collision awareness system 100, which is an example of collision awareness system 100 of FIG. 1. Collision awareness system 100 can receive data from some of all of data sources 310, 320, 140, 150, and 360, as well as data from sources not shown in FIG. 3. Vehicle 140 and object 150 shown in FIG. 3 are examples of vehicle 140 and object 150 shown in FIG. 1. For example, collision awareness system 100 may also receive data from a GNSS system and/or an inertial navigation system. Collision awareness system 100 may be configured to determine the likelihood of a collision based on the data received from data sources 310, 320, 140, 150, and/or 360. In some examples, collision awareness system 100 can be integrated with, part of, attached to, or connected to one or more of data sources 310, 320, 140, 150, and 360. The data sources for collision awareness system shown in FIG. 3 can use existing infrastructure at an airport and may not use any special installations or equipment on aircraft operating at the airport in some examples.

Camera 310 is configured to capture images within a field of view 312 and may be configured to send the captured images to collision awareness system 100. Camera 310 can be mounted at a fixed location (e.g., on a pole or building) or at a movable location (e.g., on a vehicle such as vehicle 140 or an unmanned aerial vehicle (UAV)) and, in some example, may be configured to rotate to increase field of view 312. The captured images may be visible-light images, infrared images, and/or any other type of images. Vehicle 140, object 150, and/or a potential collision location may be shown in the captured images.

Range sensor 320 is configured to transmit signals and receive reflections of those signals from a field of view 322. Range sensor 320 may be configured to generate and send radar-scan data to collision awareness system 100. Range sensor 320 can be mounted at a fixed location (e.g., on a pole or building) or at a movable location (e.g., on a vehicle such as vehicle 140 (FIG. 1) or a UAV) and, in some example, may be configured to rotate to increase field of view 322. Range sensor 320 may include a radar sensor (e.g., millimeter wave radar and/or phased-array radar), a lidar sensor, and/or an ultrasound sensor. The radar-scan data may be based on signals reflected from vehicle 140, object 150, and/or a potential collision location. The quality of radar scans can be affected by non-radiating coatings on airport objects and aircraft.

Vehicle 140 and/or object 150 may be configured to transmit surveillance messages 342 and/or 352 to collision awareness system 100. Surveillance messages 342 and 352 may include ADS-B messages, TCAS messages, a datalink messages, AIS messages, and/or any other surveillance messages. Surveillance messages 342 and 352 may include data indicating the location, velocity, heading, and/or other surveillance data for vehicle 140 and object 150.

Traffic controller 360 may be configured to transmit traffic data 362 to collision awareness system 100. Traffic data 362 may include data indicating the location and velocities of vehicles such as vehicle 140 and object 150 in examples in which object 150 is a vehicle. Traffic controller 360 may include a ground controller system at an airport and/or an air traffic controller at the airport. Additionally or alternatively, traffic controller 360 may include a control system for autonomous vehicles, such as driverless cars or UAVs.

In some examples, collision awareness system 100 is configured to determine the likelihood of a collision between vehicle 140 and object 150 based on information from only one of the data sources 310, 320, 140, 150, or 360. In other examples, collision awareness system 100 is configured to combine or fuse the data received from data sources 310, 320, 140, 150, and/or 360 to determine the likelihood of a collision between vehicle 140 and object 150. For example, collision awareness system 100 can determine the current locations of vehicle 140 and object 150 by, for example, averaging the locations of vehicle 140 and object 150 indicated by multiple data sources. As an example, if two data sources indicate different locations for vehicle 140, collision awareness system 100 can determine an estimate of the current location of vehicle 140 at the midpoint of the two different locations indicated by the data sources.

As discussed above with respect to FIG. 1, collision awareness systems described herein, including collision awareness system 100, can be onboard vehicle 140 or can separate from the vehicle. In some examples, collision awareness system 100 may be an airport-centric solution, rather than an aircraft-centric solution. Collision awareness system 100 may be configured to gather data from multiple sources and predict a collision for any of the aircraft that are conducting ground operations at the airport.

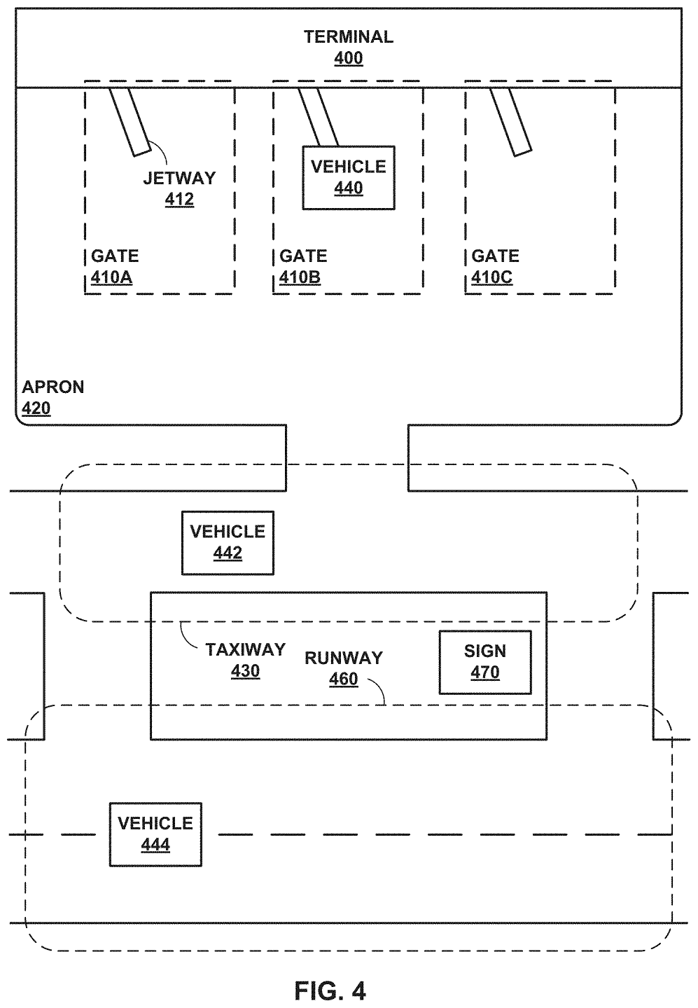

FIG. 4 is a diagram showing examples of potential collision locations at an airport. The airport depicted in FIG. 4 includes terminal 400, gates 410A, 410B, and 410C, apron 420, taxiway 430, and runway 460. Collision awareness system 100 may be configured to determine the likelihood of a collision between one or more of vehicles 440, 442, and 444, terminal 400, jetway 412, sign 470, and/or any other vehicle or object. Collision awareness system 100 may be partially or fully integrated with one of vehicles 440, 442, and 444, terminal 400, sign 470, or any other part of the airport. One or all of the vehicles 440, 442, and 444 can be examples of vehicle 140 or object 150 (FIG. 1) in various examples.

One or more cameras and/or one or more range sensors may be configured to sense the locations and/or velocities of vehicles 440, 442, and 444. The cameras and/or range sensors may then transmit data to processing circuitry 110 of collision awareness system 100 indicating the locations and/or velocities of vehicles 440, 442, and 444. Vehicles 440, 442, and 444 may be in communication with a traffic controller, such as a ground controller and/or an air traffic controller. The traffic controller may receive messages or signals from vehicles 440, 442, and 444 indicating the positions of vehicles 440, 442, and 444.

Collision awareness system 100 implementing the techniques of this disclosure may be configured to cause one or more lights mounted on vehicle 440, 442, and/or 444 to direct light towards an object that represents a collision threat or towards a potential collision location. Additionally or alternatively, collision awareness system 100 may be configured to cause one or more lights on terminal 400 or sign 470 to direct light towards vehicle 440, 442, and/or 444 or towards a potential collision location.

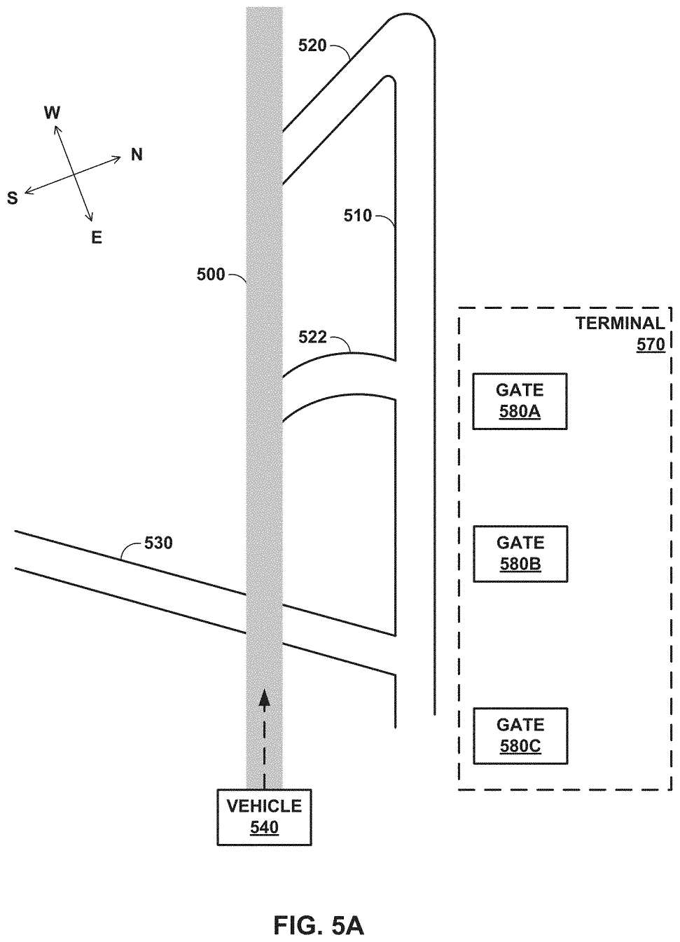

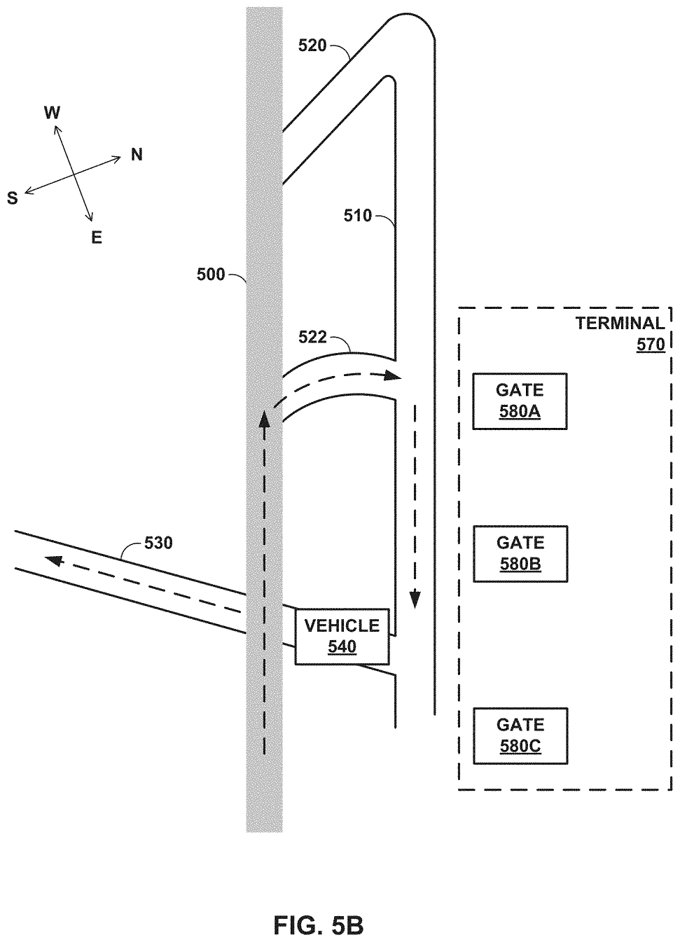

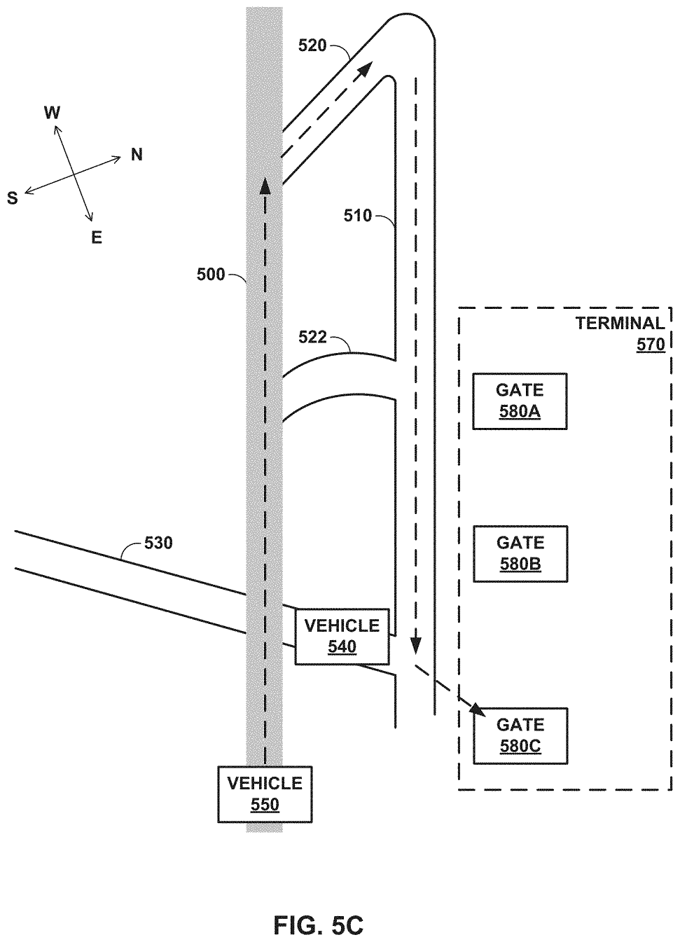

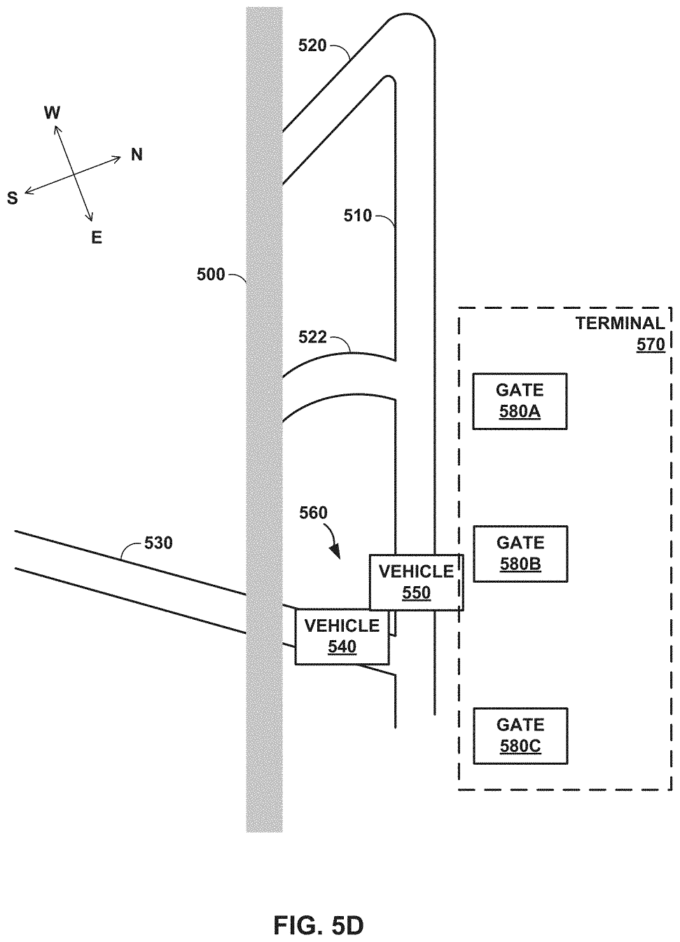

FIGS. 5A-5D are diagrams of an example scenario showing two vehicles 540 and 550 maneuvering near an airport terminal 570. Vehicle 540 and/or vehicle 550 can be an example of vehicle 140 shown in FIG. 1, and/or object 150 shown in FIG. 1. As shown in FIG. 5A, vehicle 540 lands on runway 500 and travels in a northwest direction along runway 500.

As shown in FIG. 5B, vehicle 540 receives a clearance to travel along runway 500 and use taxiway 522 to enter taxiway 510. The clearance instructs vehicle 540 to travel on taxiway 522 and make a right turn on taxiway 530 and hold short of runway 500 before proceeding southbound on taxiway 530. There may be sufficient space on taxiway 530 for vehicle 540 to park without any part of vehicle 540 obstructing vehicle travel along runway 500 or along taxiway 510. Processing circuitry 110 of collision awareness system 100 may be able to determine the location of vehicle 540 based on surveillance messages received from vehicle 540, based on an image captured of vehicle 540, based on a scan performed by a range sensor, based on clearances received from a traffic controller, and/or based on another data source.

FIG. 5C shows that vehicle 550 lands on runway 500 and travels in a northwest direction along runway 500. Shortly after vehicle 550 lands, vehicle 540 turns onto taxiway 530 and stops short of runway 500. Vehicle 550 then receives a clearance to use taxiway 520 to enter taxiway 510. The clearance instructs vehicle 550 to travel on taxiway 510 past gates 580A and 580B to gate 580C.

Nonetheless, a collision occurs between vehicles 540 and 550 at the intersection of taxiways 510 and 530, as shown in FIG. 5D. The collision is caused by not an incursion or excursion issue for runway 500, but rather the collision occurs at a taxiway intersection at relatively slow speeds. Location 560 at the intersection of taxiways 510 and 530 is an example of a potential collision location because location 560 is an intersection and because vehicle 540 is positioned near location 560. In examples in which vehicle 540 is not positioned near location 560, location 560 may not be considered a potential collision location. In this example, the ground traffic controller may not have been aware that a portion of vehicle 540 was extending into taxiway 510 while vehicle 540 was parked because the traffic controller cleared vehicle 540 to hold short of runway 500 without obstructing taxiway 510. Without access to data indicating the exact location of vehicle 540, the traffic controller instructed vehicle 550 to travel on taxiway 510 in a southeast direction towards location 560.

In some examples, processing circuitry 110 of collision awareness system 100 may be configured to also identify the type of vehicle 540 or 550 and obtain the airframe information from a database to determine the dimensions (e.g., wingspan) of vehicle 540 or 550. Processing circuitry 110 may use this information to determine if a collision likelihood at potential collision location 560 is greater than or equal to a threshold level. For example, processing circuitry 110 can determine if potential vehicle 540 is obstructing the movement of vehicles along taxiway 510 based on the dimensions of vehicle 540 and/or vehicle 550. Thus, in some examples, processing circuitry 110 can use the dimensions for vehicles 540 and 550, along with other data, in determining whether a collision between vehicles 540 and 550 is likely to occur at location 560.

The safety of vehicles 540 and 550 in the case study illustrated in FIGS. 5A-5D could be improved by close observation of taxiways 510, 520, 522, and 530. In examples in which collision awareness system 100 identifies that the likelihood a potential collision at location 560 is greater than a threshold level, processing circuitry 110 can cause one or more lights mounted on vehicle 540 or 550 to direct light towards another vehicle or object or towards location 560.

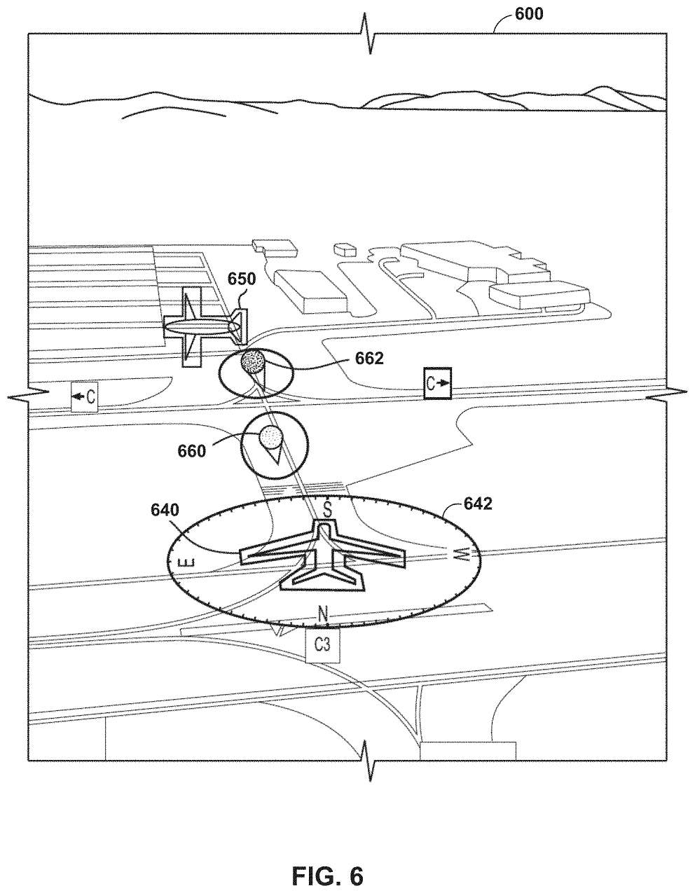

FIG. 6 is a diagram showing an example graphical user interface 600 including example indications 660 and 662 of potential collision locations. FIG. 6 shows an example graphical user interface 600 for a display to present to a vehicle operator and crewmembers or to a traffic controller. Graphical icons 660 and 662 represent potential collision locations, as determined based on the position of nearby vehicles. Graphical user interface 600 can also present alerts received from collision awareness system 100, such as an indication that the likelihood of a potential collision is greater than or equal to a threshold level. FIG. 6 depicts vehicles 640 and 650 and graphical icons 660 and 662 that can be generated and presented via any system involved in the operation, management, monitoring, or control of vehicle 640 such as a cockpit system, an electronic flight bag, a mobile device used by airport personnel and/or aircraft crew, airport guidance systems within the airport system, and visual guidance system. Vehicle 640 is an example of vehicle 140 of FIG. 1.

Graphical user interface 600 includes graphical representation 642 of a safety envelope formed around the airframe of vehicle 640. Collision awareness system 100 can construct a safety envelope for vehicle 640 based on the position, velocity, and/or airframe of vehicle 640 determined from one or more data sources described herein. Processing circuitry 110 can also use a message or instruction received by vehicle 640 from a traffic controller (e.g., a clearance) to determine a safety envelope for vehicle 640. The message or instruction received from the traffic controller may indicate an approved travel path, a future position, and/or a future maneuver for vehicle 640. In some examples, a clearance received from a traffic controller may include an instruction or command to perform a maneuver, proceed to a destination, land, takeoff, hold short of a runway, stop at a particular location and wait for further instructions, back away from a gate, and/or any other instruction. Processing circuitry 110 of collision awareness system 100 can transmit information about the safety envelope to vehicle 640 so that a display system can present, to the vehicle operator, graphical user interface 600 with graphical representation 642 showing the safety envelope.

The graphical icons 660 and 662, which indicate potential collision locations, may be color-coded. For instance, a green marking may indicate that the corresponding location is safe and no preventative action is necessary (e.g., location(s) with a low probability of collision). A yellow marking may indicate that the corresponding location may pose some risk for a collision with an object and the aircraft should approach the potential collision location with caution (e.g., location(s) with a moderate probability of collision). A red marking may indicate that vehicle 640 is likely to collide with an object at the corresponding potential collision location (e.g., location(s) with a high possibility of collision, e.g., above a predefined threshold) and a preventative action is required to avoid the collision. Further, the markings may be intuitive in that the types of the surface objects that would be potential threats for collision at the locations may be indicated within the markings.

In some examples, within the circular portion at the top of each marking (e.g., circular portions of graphical icons 660 and 662), a symbol, shape, or icon that represents the type of surface object that would be a potential threat for collision at the corresponding location may be included (e.g., visually displayed). There may be different graphical icons for a potential collision with an aircraft, with static building, with a moving vehicle, or with an airport static structure. As the vehicle 640 moves in an airport along a taxiway or runway or along an apron, processing circuitry 110 can update graphical user interface 600 to present the potential collision locations located in the planned route of the vehicle. In other words, the determination and display of vehicle 640, surface objects, graphical icons 660 and 662 for the potential collision locations may be updated in real-time.

For example, an avionics system on vehicle 640 can update the graphical icons for potential collision locations in real-time such that a new clearance received by vehicle 640 results in an update determination of which potential collision locations are relevant vehicle 640. In some examples, a collision awareness system 110 outside of vehicle 640 can determine the potential collision locations relevant to vehicle 640 based on the available data. Collision awareness system 100 can communicate the potential collision locations to vehicle 640 so that vehicle 640 can present the potential collision locations to the operator and crewmembers of vehicle 640.

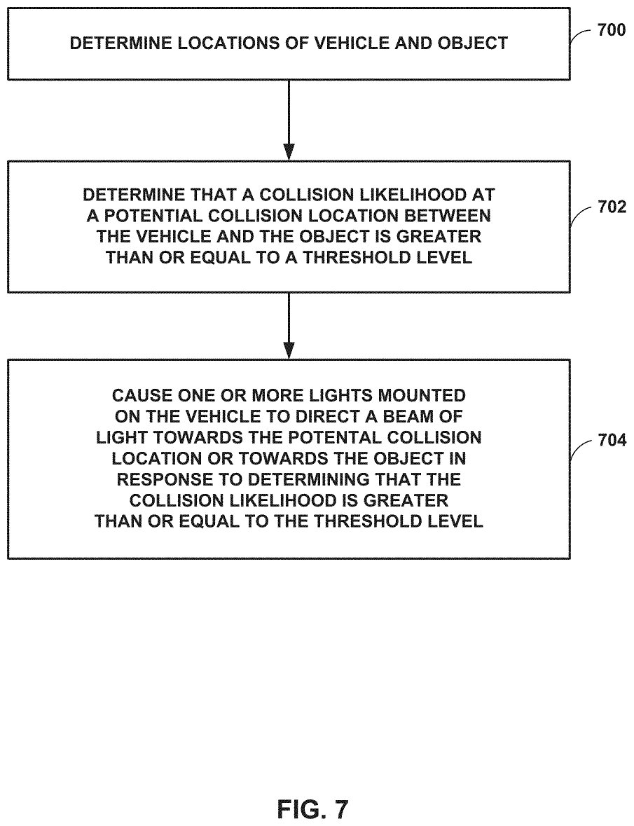

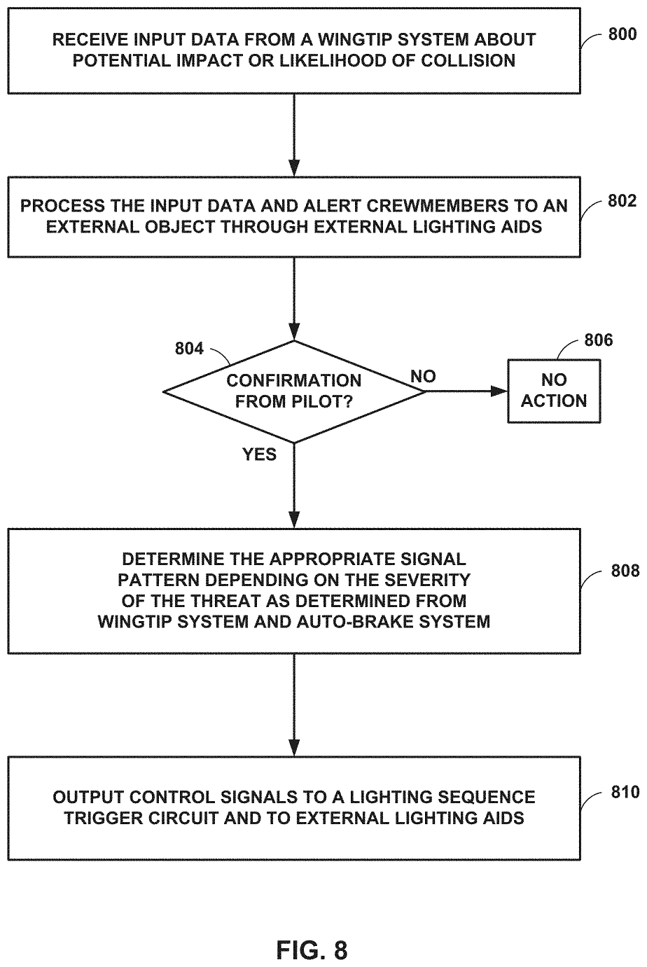

FIGS. 7 and 8 are flowcharts illustrating example processes for activating lights based on a collision likelihood. The example processes of FIGS. 7 and 8 are described with reference to processing circuitry 110 shown in FIG. 1, although other components may exemplify similar techniques. Processing circuitry 110 can perform an example process of one of FIGS. 7-10 once, or processing circuitry 110 can perform the example process periodically, repeatedly, or continually.

In the example of FIG. 7, processing circuitry 110 determines the locations of vehicle 140 and object 150 (700). Processing circuitry 110 can determine the locations of vehicle 140 and object 150 based on data from surveillance messages sent by vehicle 140 or object 150, images, range sensor scans, traffic controller data, and/or any other source. Processing circuitry 110 may be configured to also determine the velocities, headings, destinations, routes, lengths, wingspans, and/or other characteristics and parameters for vehicle 140 and object 150.

In the example of FIG. 7, processing circuitry 110 determines that a collision likelihood at potential collision location 160 between vehicle 140 and object 150 is greater than or equal to a threshold level (702). For example, processing circuitry 110 may be configured to determine the estimated times of arrival for vehicle 140 and/or object 150 at potential collision location 160. In response to determining that one or both of the estimated times of arrival are less than a threshold time duration, processing circuitry 110 may determine that the collision likelihood is greater than a threshold level. Processing circuitry 110 may be configured to select the threshold level and/or the threshold time duration based on the size and current speed of vehicle 140 and/or object 150.

In the example of FIG. 7, processing circuitry 110 causes one or more lights mounted on vehicle 40 to direct a beam of light towards potential collision location 160 or towards object 150 in response to determining that the collision likelihood for vehicle 140 at potential collision location 160 is greater than or equal to the threshold level (704). For example, processing circuitry 110 can determine which light(s) mounted on vehicle 140 are configured to direct light towards vehicle 150 or potential collision location 160. In examples in which processing circuitry 110 determines that vehicle 150 and potential collision location 160 are in front of vehicle 140, processing circuitry 110 can send command 190 to activate the front landing light(s) and/or the front taxi light(s). In some examples, collision awareness system 100 is configured to send command 190 to cause vehicle lighting system 142 to emit light 180 without any user input. In contrast, a detection-only system that presents an indication of a potential collision relies on a quick response from a vehicle operator.

Collision awareness system 100 may be configured to send command 190 to cause vehicle lighting system 142 to vary the beam angle, luminous intensity, or frequency of illumination of the lights based on the collision likelihood. For example, command 190 may instruct vehicle lighting system 142 to vary the beam angle, luminous intensity, or frequency of illumination of the lights based on the distance between vehicle 140 and object 150 or between vehicle 140 and potential collision location 160. By varying the beam angle, luminous intensity, or frequency of illumination of the lights, vehicle lighting system 142 can inform the operators of nearby vehicles about the increasing likelihood of a collision as vehicle 140 approaches potential collision location 160.

In the example of FIG. 8, processing circuitry 110 receives input data from a wingtip system about the potential impact of a collision or a likelihood of a collision (800). The wingtip system onboard vehicle 140 can include a camera 310 (FIG. 3) and/or a range sensor 320 (FIG. 3) configured to sense object 150 and other objects near vehicle 140. The wingtip system can transmit images and/or range-sensor scan data to collision awareness system 100. The wingtip system can also provide data indicating the position of potential collision location 160, the estimated time of arrival at potential collision location 160 for vehicle 140 or object 150, and the status of vehicle 140 and object 150.

Processing circuitry 110 then processes the input data and alerts crewmembers to object 150 through external lighting aids (802). For example, collision awareness system 100 can cause vehicle lighting system 142 to activate one or more lights mounted on the exterior of vehicle 140. In some examples, collision awareness system 100 may be configured to also activate one or more lights on the interior of vehicle 140 (e.g., a display or other lights in the cockpit) to inform the operator and crew of vehicle 140 of the likelihood of a collision at potential collision location 160. In some examples, vehicle lighting system 142 may be configured to send an acknowledgement to collision awareness system 100 after receiving command 190.

In some examples, collision awareness system 100 can request pilot confirmation before causing vehicle lighting system 142 to activate the lights on the exterior of vehicle 140. Processing circuitry 110 determines whether confirmation from a pilot has been received by processing circuitry 110 (804). In response to determining that processing circuitry 110 has not received confirmation from the pilot (the “NO” branch of block 804), processing circuitry 110 takes no action (806).

In response to determining that processing circuitry 110 has received confirmation from the pilot (the “YES” branch of block 804), processing circuitry 110 determines the appropriate signal pattern depending on the severity of the threat as determined from the wingtip system and the auto-brake system (808). For example, responsive to determining that the collision likelihood is greater than a first threshold level, collision awareness system 100 can send command 190 to cause vehicle lighting system 142 to activate one or more lights on vehicle 140 in a first pattern. In response to determining that the collision likelihood is greater than a second threshold level that is different than the first threshold level, collision awareness system 100 can send command 190 to cause vehicle lighting system 142 to activate one or more lights on vehicle 140 in a second pattern that is different than the first pattern.

The first and second signal patterns can differ based on the frequency of blinking of the lights, the length of each blink, and/or the intensity of the light emitted. As an example, to indicate a closer or more urgent collision threat, vehicle lighting system 142 can increase the blinking frequency or increase the light intensity. In some examples, when system 100 initially detects a collision, system 100 can command vehicle lighting system 142 to create light at a default intensity (e.g., by activating fewer than all available lights and/or by changing the intensity of light emitted by particular lights), and as vehicle 140 approaches potential collision location 160, system 100 can command vehicle lighting system 142 to direct light at an increased intensity (e.g., by activating more lights and/or by increasing the intensity of light emitted by the particular lights) towards potential collision location 160.

In some examples in which the first threshold level is associated with a more urgent collision threat or a higher likelihood of than the second threshold level, the first pattern may include a higher frequency of illumination or a brighter illumination than the second pattern. In addition to or instead of varying the patterns based on a frequency or illumination brightness, in some examples, the first pattern may include the activation of more or fewer lights that are activated in the second pattern. Using different lighting patterns based on the urgency of the collision threat can inform nearby vehicle operators as the urgency of a potential collision.

In some examples, collision awareness system 100 can also cause vehicle lighting system 142 to use different lighting patterns based on potential collision location or based on the type of object 150. For example, collision awareness system 100 can select a first lighting pattern in response to determining that potential collision location 160 is on a taxiway of an airport, a second lighting pattern in response to determining that potential collision location 160 is on an apron of the airport, and a third lighting pattern in response to determining that potential collision location 160 is on a runway of the airport. Certain lighting patterns may be more observable on an apron, while other lighting patterns may be more observable on a taxiway. Collision awareness system 100 can also select a first lighting pattern in response to determining that object 150 is a vehicle and select a second lighting pattern in response to determining that object 150 is a sign, pole, or building.

Processing circuitry 110 outputs command 190 to a lighting sequence trigger circuit and to external lighting aids (810). In examples in which collision awareness system 100 is remote from vehicle 140, collision awareness system 100 may be configured to transmit command 190 via wireless communication. Processing circuitry 110 can cause vehicle lighting system 142 to flash a high beam with a rotating head or a static red beam to alert anyone in the proximity.

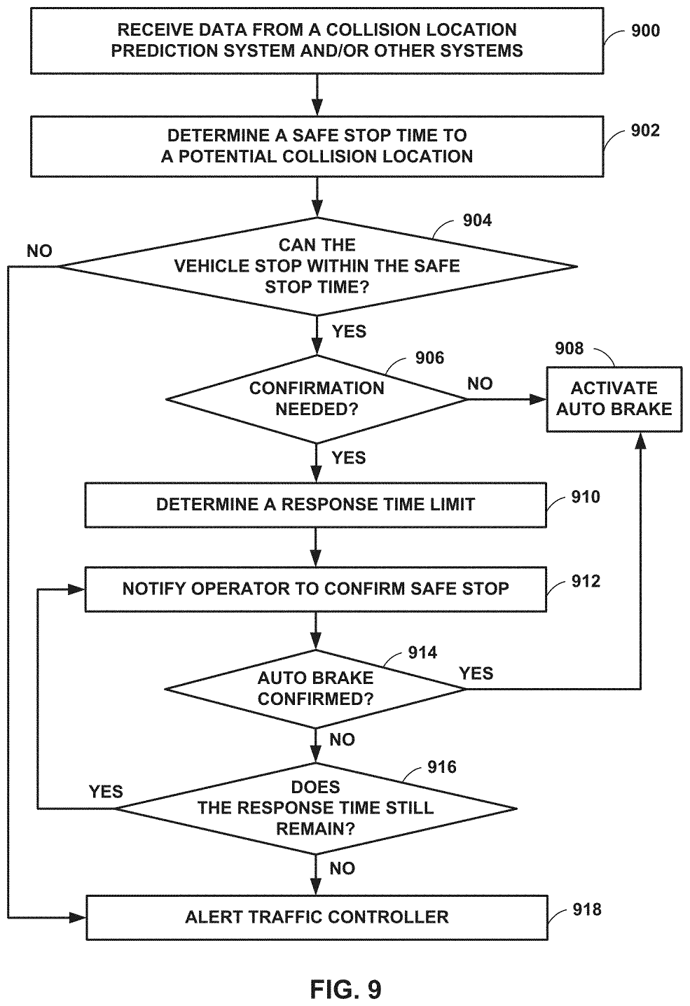

FIG. 9 is a flowchart illustrating an example process for activating an automatic brake system. The example process of FIG. 9 is described with reference to processing circuitry 110 shown in FIG. 1, although other components may exemplify similar techniques. For example, some or all of the example process of FIG. 9 can be performed by a control system of vehicle 140, which may be integrated with or separate from collision awareness system 100.

In the example of FIG. 9, processing circuitry 110 receives data from a collision location prediction system and/or other systems (900). Processing circuitry 110 may also receive data directly from a cockpit system and/or an airport system, such as data indicating the real-time vehicle position and other vehicle characteristics. The real-time vehicle position and characteristics may include the distance from vehicle 140 to object 150, the distance from vehicle 140 to potential collision location 160, the estimated arrival time of vehicle 140 and/or object 150 at the potential collision location 160, an estimated stopping time or distance for vehicle 140 and/or object 150. Additionally or alternatively, processing circuitry 110 may be configured to receive data indicating the weight, momentum, speed, and/or heading of vehicle 140 or object 150.

In the example of FIG. 9, processing circuitry 110 determines a safe stop time to a potential collision location (902). A safe stop time may mean a time within which a vehicle may come to a stop in order to safely avoid a collision at a potential collision location 160. Processing circuitry 110 also determines whether vehicle 140 can stop within a safe stop time (904). Processing circuitry 110 can determine that vehicle 140 can stop within the safe stop time by at least determining that the estimated time of arrival of vehicle 140 at potential collision location 160 is greater than a safe buffer time. The safe buffer time may be a maximum stopping time for vehicle 140 based on vehicle weight, speed, and surface conditions and can be stored in memory 122 (FIG. 1) of collision avoidance system 100 or another device. In response to determining that vehicle 140 cannot stop within the safe stop time (the “NO” branch of block 904), processing circuitry 110 alerts a traffic controller to the potential collision (918). Processing circuitry 110 can also send an alert to vehicle 140, object 150, and any other persons, vehicles, or systems that are nearby or that may be impacted by the potential collision.

In response to determining that vehicle 140 can stop within the safe stop time (the “YES” branch of block 904), processing circuitry 110 determines whether confirmation from the operator of vehicle 140 is needed to activate the auto-brake system (906). Confirmation may be needed from the operator of vehicle 140 depending on the size, weight, and/or type of vehicle 140. Additionally or alternatively, confirmation may be needed from the operator of vehicle 140 depending on whether vehicle 140 is a manned or unmanned (e.g., driverless, remotely controlled, and/or autonomous) vehicle. In response to determining that operator confirmation is not needed (the “NO” branch of block 906), processing circuitry 110 transmits command 190 to vehicle 140 to activate braking system 144 (908). In some examples, a default setting of braking system 144 may require operator confirmation to activate the brakes of vehicle 140. However, if it is determined that vehicle 140 is approaching potential collision location 160 with such momentum or speed that the safe stop time barely allows vehicle 140 to come to a stop (e.g., within a threshold distance from potential collision location 160) without collision, the default setting may be overridden to activate braking system 140 immediately. However, the automatic override capability may be optional and braking system 140 may be implemented only with the default setting and/or the manual override.

In response to determining that operator confirmation is needed (the “YES” branch of block 906), processing circuitry 110 determines a response time limit for the operator of vehicle 140 (910). The response time limit is a time within which an operator may confirm the application of the brakes of vehicle 140 in order to bring vehicle 140 to a safe stop without colliding with object 150 at potential collision location 160. Processing circuitry 110 then notifies the operator to confirm safe stop (912). In some examples, processing circuitry 110 can also cause a navigation system in vehicle 140 to present a recommendation to the operator, such as a recommendation to apply the brakes or a recommendation to activate exterior lights 142. Vehicle 140 can present a visual notification or alert via a display system on the dashboard or in the cockpit of vehicle 140. In some examples, vehicle 140 can present other types of notification or alert to the operator and/or crew, such as an audible or haptic notification/alert.

Processing circuitry 110 then determines whether the operator confirmed the auto-braking (914). In response to determining that the operator confirmed the auto-braking (the “YES” branch of block 914), processing circuitry 110 transmits command 190 to vehicle 140 to activate braking system 144 (908). By automatically activating braking system 144, collision awareness system 100 can reduce the wear and tear for braking system 144 and increase the life of the brakes if vehicle 140 applies the brakes when vehicle 140 is still short of the minimum stopping distance (for example, if the potential collision is resolved in the additional time gained by braking early). By braking early to slow down vehicle 140, collision awareness system 100 provides the operator and collision awareness system 100 more time to evaluate the potential collision threat. In response to determining that the operator did not confirm the auto-braking (the “NO” branch of block 914), processing circuitry 110 determines whether there is still sufficient response time (916). In other words, processing circuitry 110 can determine whether vehicle 140 is still within the time window within which the operator of vehicle 140 may confirm the auto brake to bring vehicle 140 to a safe stop. To determine whether there is still sufficient response time, processing circuitry 110 can subtract the time elapsed since the time when the response time was previously determined from the previously-determined response time.

In response to determining that there is still sufficient response time (the “YES” branch of block 916), processing circuitry 110 notifies the operator to confirm the safe stop (912). Processing circuitry 110 can perform the sequence of steps 912, 914, and 916 iteratively until the operator confirms the auto braking or there is no remaining response time. In response to determining that there is no longer sufficient response time (the “NO” branch of block 916), processing circuitry 110 alerts the traffic controller (918).

In some examples, processing circuitry 110 may be configured to also determine the braking deceleration points for vehicle 140. The braking deceleration points may be associated with a safe stop time, operator response time, and minimum braking distance. There may be different deceleration points for expected vehicle maneuvers such as turn, holding short, and approaching an intersection. Processing circuitry 110 can use the braking deceleration points to develop an optimum brake force profile. Processing circuitry 110 can cause surface lights, such as taxiway lights at an airport, to provide an indication to the operator of vehicle 140 of the braking deceleration points. The operator of vehicle 140 may use the surface lights to determine the urgency of a potential collision. Collision awareness system 100 can also cause a vehicle display system to provide indications of the braking deceleration points to the operator of vehicle 140.

Collision awareness system 100 may be configured to check whether the braking points of two vehicles overlap. Collision awareness system 100 could issue an alert or activate lights in response to determining that the braking points of two vehicles overlap or that there is a threshold amount of overlap. Collision awareness system 100 may be configured to also check for any violations of standard operating procedures by vehicle 140 or object 150 and use these violations to determine the likelihood of a potential collision.

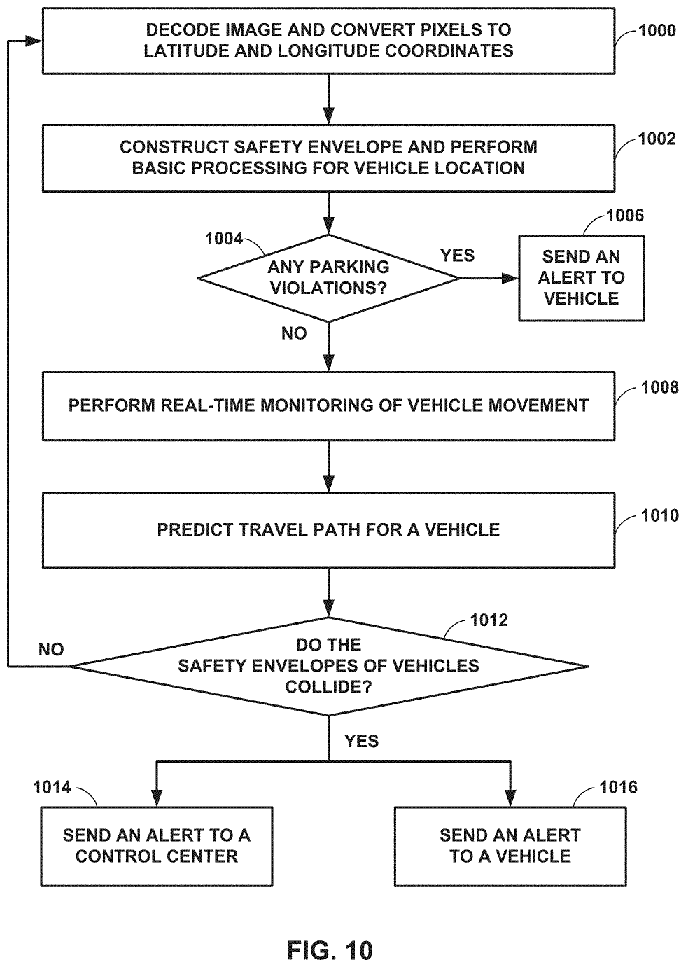

FIG. 10 is a flowchart illustrating an example process for generating an alert based on a collision prediction. The example process of FIG. 10 is described with reference to processing circuitry 110 shown in FIG. 1, although other components may exemplify similar techniques. For example, some or all of the example process of FIG. 10 can be performed by a control system of vehicle 140, which may be integrated with or separate from collision awareness system 100.

In the example of FIG. 10, processing circuitry 110 decodes an image received from camera 310 (FIG. 3) and converts the pixels of the image to latitude and longitude coordinates (1000). Camera 310 may be mounted on vehicle 140, on vehicle 150, or on a pole or building near vehicle 140, vehicle 150, or potential collision location 160. Processing circuitry 110 can also receive information from one or more other data sources shown in FIG. 3, a navigation database, an airport database, augmented position systems, and surveillance messages, visual docking stations at an airport, and transcripts of clearances issued by a controller. Using the data from image and other data sources, processing circuitry 110 constructs a safety envelope around vehicle 140 or object 150 and performs basic processing for the location of vehicle 140 and object 150 (1002).

Processing circuitry 110 determines whether any parking violations exist (1004). In response to determining that a parking violation exists (the “YES” branch of block 1004), processing circuitry 110 sends an alert to vehicle 140, object 150, and/or a traffic controller (1006). This alert to vehicle 140 may include command 190 to activate vehicle lighting system 142 and/or a visible or audible alert presented in the cockpit or cabin of vehicle 140 to the operator and crewmembers of vehicle 140. In response to determining that no parking violations exist (the “NO” branch of block 1004), processing circuitry 110 performs real-time monitoring of the movement of vehicle 140 and/or object 150 (1008). Processing circuitry 110 may use the real-time positions of vehicle 140 and object 150 received via augmented position receivers and airport visual guidance systems. Processing circuitry 110 also can monitor the potential collision location to determine whether any vehicle is positioned incorrectly such that a collision is possible.

Processing circuitry 110 predicts a travel path for vehicle 140 (1010). Processing circuitry 110 can base the real-time predicted travel path across the airport surface on the instructions in a clearance, data from augmented position sensors, ADS-B data, datalink data, and images received from camera 310 or other data sources shown in FIG. 3. Processing circuitry 110 can use the travel path to construct a safety envelope for vehicle 140. Processing circuitry 110 then determines whether the safety envelope of vehicle 140 collides with object 150 (1012) or whether the safety envelope of vehicle 140 collides with a safety envelope of object 150. Processing circuitry 110 can also construct safety envelope for object 150 and determine whether the two safety envelopes collide. Processing circuitry 110 can use a period of time to determine whether a collision occurs within the period of time. Additionally or alternatively, processing circuitry 110 can determine whether there is a threshold amount of overlap between the safety envelopes around vehicle 140 and object 150. In response to determining that the safety envelopes do not collide, processing circuitry 110 can stop the process or return to step 1000.

In response to determining that the safety envelope collide, processing circuitry 110 sends an alert to a control center, such as a ground controller or an air traffic controller (1014). Processing circuitry 110 can direct the alert to an airport guidance system such as an advanced surface movement and guidance control system and a visual guidance system. Processing circuitry 110 also sends command 190 to vehicle 140 to activate vehicle lighting system 142 to direct light 180 towards object 150 or towards potential collision location 160 (1016).

The following numbered examples demonstrate one or more aspects of the disclosure.

Example 1. A method includes determining that a collision likelihood at a potential collision location between a vehicle and an object is greater than or equal to a threshold level. The method also includes causing one or more lights mounted on the vehicle to direct light towards the potential collision location or towards the object in response to determining that the collision likelihood for the vehicle at the potential collision location is greater than or equal to the threshold level.

Example 2. The method of example 1, further including causing the one or more lights to vary at least one of a beam angle, luminous intensity, or frequency of illumination of the one or more lights based on the collision likelihood for the vehicle.

Example 3. The method of example 1 or example 2, further including causing the one or more lights to vary at least one of a beam angle, luminous intensity, or frequency of illumination of the one or more lights based on a distance between the vehicle and the potential collision location.

Example 4. The method of examples 1-3 or any combination thereof, wherein the one or more lights are mounted on an exterior of the vehicle.

Example 5. The method of examples 1-4 or any combination thereof, wherein the vehicle is an aircraft.

Example 6. The method of examples 1-5 or any combination thereof, wherein the one or more lights comprises a landing light mounted on the exterior of the aircraft or a light mounted on a wingtip of the aircraft.

Example 7. The method of examples 1-6 or any combination thereof, wherein the threshold level for collision prediction comprises a time value or a distance value.

Example 8. The method of examples 1-7 or any combination thereof, wherein determining that the collision likelihood is greater than or equal to the threshold level comprises determining that the collision likelihood for the vehicle is greater than or equal to a first threshold level.

Example 9. The method of examples 1-8 or any combination thereof, further including activating the one or more lights in a first pattern in response to determining that the collision likelihood is greater than or equal to the first threshold level

Example 10. The method of examples 1-9 or any combination thereof, further including determining that the collision likelihood for the vehicle is greater than or equal to a second threshold level

Example 11. The method of examples 1-10 or any combination thereof, further including activating the one or more lights in a second pattern in response to determining that the collision likelihood is greater than or equal to the second threshold level, the second pattern being different than the first pattern.

Example 12. The method of examples 1-11 or any combination thereof, wherein the first threshold level is associated with a more urgent collision threat than the second threshold level.

Example 13. The method of examples 1-12 or any combination thereof, wherein the first pattern comprises a higher frequency of illumination for the one or more lights than the second pattern.

Example 14. The method of examples 1-13 or any combination thereof, further including determining a location of the vehicle.

Example 15. The method of examples 1-14 or any combination thereof, further including activating the one or more lights in a first pattern in response to determining that the determined location of the vehicle is on an apron of the airport, the second pattern being different than the first pattern.

Example 16. The method of examples 1-15 or any combination thereof, further including activating the one or more lights in a second pattern in response to determining that the determined location of the vehicle is on a taxiway of an airport.

Example 17. The method of examples 1-16 or any combination thereof, further including determining a type of the object.

Example 18. The method of examples 1-17 or any combination thereof, further including activating the one or more lights in a first pattern in response to determining that the object is another vehicle.

Example 19. The method of examples 1-18 or any combination thereof, further including activating the one or more lights in a second pattern in response to determining that the object is an airport structure, the second pattern being different than the first pattern.

Example 20. The method of examples 1-19 or any combination thereof, further including storing a clearance for the vehicle indicating a traffic status of the vehicle.

Example 21. The method of examples 1-20 or any combination thereof, further including determining the collision likelihood by determining a safety envelope for the vehicle based on a clearance;

Example 22. The method of examples 1-21 or any combination thereof, further including determining the collision likelihood by determining a corresponding safety envelope of the object.

Example 23. The method of examples 1-22 or any combination thereof, further including determining the collision likelihood by determining that the safety envelope of the vehicle overlaps with the safety envelope of the object.

Example 24. The method of examples 1-23 or any combination thereof, further including varying a luminous intensity of the one or more lights based on ambient light conditions or visibility conditions.

Example 25. The method of examples 1-24 or any combination thereof, further including activating a braking system of the vehicle in response to determining that the collision likelihood for the vehicle is greater than or equal to the threshold level.

Example 26. The method of examples 1-25 or any combination thereof, further including causing a navigation system to present a recommendation to an operator of the vehicle for activating a braking system of the vehicle in response to determining that the collision likelihood for the vehicle is greater than or equal to the threshold level.

Example 27. A system includes a memory configured to store a threshold level for collision prediction. The system also includes processing circuitry configured to determine that a collision likelihood at a potential collision location between the vehicle and an object is greater than or equal to the threshold level. The processing circuitry is also configured to cause one or more lights mounted on the vehicle to direct light towards the potential collision location or towards the object in response to determining that the collision likelihood for the vehicle is greater than or equal to the threshold level.

Example 28. The system of example 27, where the processing circuitry is configured to perform the method of examples 1-26 or any combination thereof.

Example 29. The system of example 27 or example 28, wherein the one or more lights are mounted on an exterior of the vehicle.

Example 30. The system of examples 27-29 or any combination thereof, wherein the vehicle is an aircraft.

Example 31. The system of examples 27-30 or any combination thereof, wherein the one or more lights comprises a landing light mounted on the exterior of the aircraft or a light mounted on a wingtip of the aircraft.

Example 32. The system of examples 27-31 or any combination thereof, wherein the threshold level for collision prediction comprises a time value or a distance value.

Example 33. The system of examples 27-32 or any combination thereof, wherein the first threshold level is associated with a more urgent collision threat than the second threshold level.

Example 34. The system of examples 27-33 or any combination thereof, wherein the memory is configured to store a clearance for the vehicle indicating a traffic status of the vehicle.

Example 35. A device includes a computer-readable medium having executable instructions stored thereon, configured to be executable by processing circuitry for causing the processing circuitry to determine that a collision likelihood at a potential collision location between the vehicle and an object is greater than or equal to the threshold level. The instructions are configured to cause the processing circuitry is also configured to cause one or more lights mounted on the vehicle to direct light towards the potential collision location or towards the object in response to determining that the collision likelihood for the vehicle is greater than or equal to the threshold level.

Example 36. The device of example 35, where the instructions are configured to cause the processing circuitry is configured to perform the method of examples 1-26 or any combination thereof.

Example 37. A system includes means for causing the processing circuitry to determine that a collision likelihood at a potential collision location between the vehicle and an object is greater than or equal to the threshold level. The system also includes means for causing one or more lights mounted on the vehicle to direct light towards the potential collision location or towards the object in response to determining that the collision likelihood for the vehicle is greater than or equal to the threshold level.

Example 38. The system of example 37, further including means for performing the method of examples 1-26 or any combination thereof.

The disclosure contemplates computer-readable storage media including instructions to cause a processor to perform any of the functions and techniques described herein. The computer-readable storage media may take the example form of any volatile, non-volatile, magnetic, optical, or electrical media, such as a random access memory (RAM), read-only memory (ROM), non-volatile RAM (NVRAM), electrically erasable programmable ROM (EEPROM), or flash memory. The computer-readable storage media may be referred to as non-transitory. A computing device may also contain a more portable removable memory type to enable easy data transfer or offline data analysis.

The techniques described in this disclosure, including those attributed to collision awareness system 100, processing circuitry 110, receiver 120, memory 122, transmitter 124, vehicles 140, 240, 440, 442, 444, 540, and 560, object 150, camera 310, range sensor 320, and/or traffic controller 360, and various constituent components, may be implemented, at least in part, in hardware, software, firmware or any combination thereof. For example, various aspects of the techniques may be implemented within one or more processors, including one or more microprocessors, digital signal processors (DSPs), application-specific integrated circuits (ASICs), field-programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry.

As used herein, the term “circuitry” refers to an ASIC, an electronic circuit, a processor (shared, dedicated, or group) and memory that execute one or more software or firmware programs, a combinational logic circuit, or other suitable components that provide the described functionality. The term “processing circuitry” refers one or more processors distributed across one or more devices. For example, “processing circuitry” can include a single processor or multiple processors on a device. “Processing circuitry” can also include processors on multiple devices, wherein the operations described herein may be distributed across the processors and devices.

Such hardware, software, firmware may be implemented within the same device or within separate devices to support the various operations and functions described in this disclosure. For example, any of the techniques or processes described herein may be performed within one device or at least partially distributed amongst two or more devices, such as between collision awareness system 100, processing circuitry 110, receiver 120, memory 122, transmitter 124, vehicles 140, 240, 440, 442, 444, 540, and 560, object 150, camera 310, range sensor 320, and/or traffic controller 360. Such hardware may support simultaneous or non-simultaneous bi-directional messaging and may act as an encrypter in one direction and a decrypter in the other direction. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components, or integrated within common or separate hardware or software components.

The techniques described in this disclosure may also be embodied or encoded in an article of manufacture including a non-transitory computer-readable storage medium encoded with instructions. Instructions embedded or encoded in an article of manufacture including a non-transitory computer-readable storage medium encoded, may cause one or more programmable processors, or other processing circuitry, to implement one or more of the techniques described herein, such as when instructions included or encoded in the non-transitory computer-readable storage medium are executed by the one or more processors or other processing circuitry.

In some examples, a computer-readable storage medium includes non-transitory medium. The term “non-transitory” may indicate that the storage medium is not embodied in a carrier wave or a propagated signal. In certain examples, a non-transitory storage medium may store data that can, over time, change (e.g., in RAM or cache). Elements of devices and circuitry described herein, including, but not limited to, collision awareness system 100, processing circuitry 110, receiver 120, memory 122, transmitter 124, vehicles 140, 240, 440, 442, 444, 540, and 560, object 150, camera 310, range sensor 320, and/or traffic controller 360, may be programmed with various forms of software. The one or more processors or other processing circuitry may be implemented at least in part as, or include, one or more executable applications, application modules, libraries, classes, methods, objects, routines, subroutines, firmware, and/or embedded code, for example.

Various examples of the disclosure have been described. Any combination of the described systems, operations, or functions is contemplated. These and other examples are within the scope of the following claims.

What is claimed is:

1. A system comprising:
a memory configured to store a threshold level for collision prediction; and
processing circuitry configured to:
determine that a collision likelihood at a potential collision location between the vehicle and an object is greater than or equal to the threshold level; and
cause one or more lights mounted on the vehicle to direct light towards the potential collision location or towards the object in response to determining that the collision likelihood for the vehicle is greater than or equal to the threshold level.

2. The system of claim 1, wherein the processing circuitry is further configured to cause the one or more lights to vary at least one of a beam angle, luminous intensity, or frequency of illumination of the one or more lights based on the collision likelihood for the vehicle.

3. The system of claim 1, wherein the processing circuitry is further configured to cause the one or more lights to vary at least one of a beam angle, luminous intensity, or frequency of illumination of the one or more lights based on a distance between the vehicle and the potential collision location.

4. The system of claim 1, wherein the one or more lights are mounted on an exterior of the vehicle.

5. The system of claim 4,
wherein the vehicle is an aircraft, and
wherein the one or more lights comprises a landing light mounted on the exterior of the aircraft or a light mounted on a wingtip of the aircraft.

6. The system of claim 1, wherein the threshold level for collision prediction comprises a time value or a distance value.

7. The system of claim 1,
wherein the processing circuitry is configured to determine that the collision likelihood is greater than or equal to the threshold level by at least determining that the collision likelihood for the vehicle is greater than or equal to a first threshold level,
wherein the processing circuitry is further configured to:
activate the one or more lights in a first pattern in response to determining that the collision likelihood is greater than or equal to the first threshold level;
determine that the collision likelihood for the vehicle is greater than or equal to a second threshold level; and
activate the one or more lights in a second pattern in response to determining that the collision likelihood is greater than or equal to the second threshold level, the second pattern being different than the first pattern.

8. The system of claim 7,
wherein the first threshold level is associated with a more urgent collision threat than the second threshold level, and
wherein the first pattern comprises a higher frequency of illumination for the one or more lights than the second pattern.

9. The system of claim 1,
wherein the processing circuitry is further configured to determine a location of the vehicle, and
wherein the processing circuitry is configured to activate the one or more lights by at least:
activating the one or more lights in a first pattern in response to determining that the determined location of the vehicle is on a taxiway of an airport; and
activating the one or more lights in a second pattern in response to determining that the determined location of the vehicle is on an apron of the airport, the second pattern being different than the first pattern.

10. The system of claim 1, wherein the processing circuitry is further configured to:
determine a type of the object;
activate the one or more lights in a first pattern in response to determining that the object is another vehicle; and
activate the one or more lights in a second pattern in response to determining that the object is an airport structure, the second pattern being different than the first pattern.

11. The system of claim 1,
wherein the memory is configured to store a clearance for the vehicle indicating a traffic status of the vehicle, and
wherein the processing circuitry is configured to determine the collision likelihood by at least:
determining a safety envelope for the vehicle based on the clearance;
determining a location of the object;
determining a corresponding safety envelope of the object; and
determining that the safety envelope of the vehicle overlaps with the safety envelope of the object.

12. The system of claim 1, wherein the processing circuitry is further configured to vary a luminous intensity of the one or more lights based on ambient light conditions or visibility conditions.

13. The system of claim 1, wherein the processing circuitry is further configured to activate a braking system of the vehicle in response to determining that the collision likelihood for the vehicle is greater than or equal to the threshold level.

14. The system of claim 1, wherein the processing circuitry is further configured to cause a navigation system to present a recommendation to an operator of the vehicle for activating a braking system of the vehicle in response to determining that the collision likelihood for the vehicle is greater than or equal to the threshold level.

15. A method comprising:
determining that a collision likelihood at a potential collision location between a vehicle and an object is greater than or equal to a threshold level; and
causing one or more lights mounted on the vehicle to direct light towards the potential collision location or towards the object in response to determining that the collision likelihood for the vehicle at the potential collision location is greater than or equal to the threshold level.

16. The method of claim 15, further comprising varying at least one of a beam angle, luminous intensity, or frequency of illumination of the one or more lights based on the collision likelihood for the vehicle.

17. The method of claim 15, further comprising varying at least one of a beam angle, luminous intensity, or frequency of illumination of the one or more lights based on a distance between the vehicle and the potential collision location.

18. The method of claim 15, wherein the threshold level for collision prediction comprises a time value or a distance value.

19. The method of claim 15,
wherein determining that the collision likelihood is greater than or equal to the threshold level comprises determining that the collision likelihood for the vehicle is greater than or equal to a first threshold level,
wherein the method further comprises:
activating the one or more lights in a first pattern in response to determining that the collision likelihood is greater than or equal to the first threshold level;
determining that the collision likelihood for the vehicle is greater than or equal to a second threshold level; and
activating the one or more lights in a second pattern in response to determining that the collision likelihood is greater than or equal to the second threshold level, the second pattern being different than the first pattern.

20. A device comprising a computer-readable medium having executable instructions stored thereon, configured to be executable by processing circuitry for causing the processing circuitry to:
determine that a collision likelihood at a potential collision location between a vehicle and an object is greater than or equal to a threshold level; and
cause one or more lights mounted on the vehicle to direct light towards the potential collision location or towards the object in response to determining that the collision likelihood for the vehicle is greater than or equal to the threshold level.
